(19) United States
(12) Patent Application Publication
(10) Pub. No.: US 2003/0042011 A1
(43) Pub. Date: Mar. 6, 2003

(54) Device for generating an air stream at a set temperature for the cabin of a motor vehicle and heating and/or air-conditioning apparatus comprising this device

(75) Inventor: Philippe Vincent, Epernon (FR)

Correspondence Address: Liniak, Berenato, Longacre & White, 6550 Rock Spring Drive, Ste. 240, Bethesda, MD, 20817, US

(73) Assignee: VALEO CLIMATISATION, La verriere (FR)

(21) Appl. No.: 10/215,085

(22) Filed: Aug. 9, 2002

(30) Foreign Application Priority Data
Aug. 30, 2001 (FR) 01 11270

(51) Int. Cl. B60H 3/00; B61D 27/00; B60H 1/00

(52) U.S. Cl. 165/203; 165/42; 165/43

(57) ABSTRACT

The device for generating an air stream comprises means (22, 26) for distributing a main air stream (10) and heating means (20) for producing a hot secondary air stream (42). A modular assembly may be attached into the casing (4) of a heating and/or air-conditioning apparatus (2). This modular assembly exists in at least three versions, suited to the production of an air stream at a set temperature to supply one, two or three regions of the cabin of a motor vehicle. The external bulk of the modular assembly is identical regardless of the number of regions in the cabin for which it is intended. The modular assembly may comprise a support frame (70) and a partition plate (72) attached or incorporated into the support frame and dividing the latter into two parts.

The invention relates to the field of apparatuses for the heating, ventilation and/or air-conditioning of the cabin of a motor vehicle.

More specifically, the invention relates to a device for generating an air stream at a set temperature for supplying air at a set temperature to one or more regions of the cabin of a motor vehicle, this device comprising means for distributing a main air stream to split this air stream in adjustable proportions into a cold secondary air stream and a secondary air stream for heating, and heating means for heating the secondary air stream for heating so as to produce a hot secondary air stream.

It also relates to an apparatus for heating and/or air-conditioning the cabin of a motor vehicle comprising this device for generating air at a set temperature.

In order to reduce motor vehicle development and production costs, manufacturers are increasingly standardizing their ranges. In order to maintain diversity within the range of their vehicles, they vary the option and equipment levels of these vehicles. This standardization policy applies in particular to heating and/or air-conditioning apparatuses.

These apparatuses comprise a casing which delimits a main air passage through which a main air stream flows. This air is taken in from outside the vehicle (possibly from inside the cabin of the vehicle). It is circulated by a blower. In most instances, and increasingly often, the heating apparatus is equipped with an air conditioner. All of the main air flow passes the evaporator of the air-conditioning circuit, and this advantageously allows it to be dehumidified. However, entry-level heating apparatuses do not have an air-conditioning device, which means that the air stream is at the ambient external temperature.

The main air passage of the heating and/or air-conditioning apparatus is divided into a cold air duct and a hot air duct in which a heater matrix is installed. A means such as a shutter, commonly known as the “mixing shutter”, makes it possible either for the cold air duct to be shut off so that all of the main air stream passes through the heat matrix (“hot mode”), or for the hot air duct to be shut off (“cold mode”), or alternatively for the main air stream to be split in variable proportions between the cold air duct and the hot air duct. Downstream of the cold air duct and of the hot air duct in the direction of flow of the air stream there is a volume known as a mixing chamber in which the hot and cold streams mix together again. Thus, the mixing shutter or, more generally, the mixing device makes it possible to set the temperature of the air stream leaving the apparatus between a minimum temperature (the temperature of the cold air stream) and a maximum temperature (the temperature of the hot air stream).

Air outlet ducts allow the air stream at the set temperature to be conveyed to various points in the cabin of the vehicle. The apparatus may have three outlets (deicing the windshield, dashboard vent outlets and those for heating the feet). It may also have a fourth outlet which conveys air to the rear seats of the vehicle. Distribution shutters arranged in the outlets make it possible to set the air flow rate passing these outlets. There are various versions of heating and/or air-conditioning apparatus. Entry-level vehicles are equipped with a heating and/or air-conditioning apparatus of the single-region type. In a first alternative form, the air supplied to the cabin is distributed throughout the cabin which then forms just one volume. There is no possibility of adjusting the distribution of the air separately or in principle of setting the temperature for various regions in the cabin of the vehicle. In a more elaborate alternative form, the single-region heating and/or air-conditioning apparatuses allow the distribution of air to be adjusted to the various regions, but the temperature of the air is the same in each of these regions. In other words, there is no possibility of setting the air temperature separately for the various regions.

Vehicles which have a higher level of equipment are equipped with a multi-region, for example two-region or three-region, heating and/or air-conditioning apparatus. In these apparatuses, it is possible to set not only the amount of air delivered to each of the regions but also the temperature of this air independently from one region to another. In an apparatus of the two-region type, the cabin of the vehicle is divided into a left-hand region and a right-hand region. It is possible to set the distribution of the air to the left-hand region and to the right-hand region independently, and also to set the temperatures independently. In a vehicle equipped with a three-region heating apparatus, the cabin of the vehicle is divided into a front left-hand region, a front right-hand region and a rear region. It is possible independently to set the distribution and temperature of the air for each of these regions. It would also be possible to design a heating apparatus of the four-region type in which it would be possible independently to set the temperature and the distribution of the air to the left-hand and right-hand rear seats.

This management of various levels of comfort requires a different design of the apparatus according to the level of comfort to be met. For example, producing a three-region heating and/or air-conditioning apparatus entails compartmentalizing the hot and cold air streams into three independent circuits and entails different aerothermal optimization by comparison with a single-region or two-region version. In consequence, the internal design of the heating apparatuses needs to be changed. This varies according to the various versions of the apparatus. This results in numerous disadvantages. It is necessary to manage different tools for manufacturing the various versions. This management is complicated. It poses logistic problems and gives rise to high costs. Furthermore, it incurs risks of error (error in version, omission of certain parts, etc.). Certain variants of apparatus to be produced may also entail more complex shapes so as, in particular, to be able to demold all the useful shapes. These complex shapes are not necessary for all the versions of the apparatus. The cost of the simpler versions is therefore needlessly increased.

The method of assembling the apparatus has also to be designed to satisfy all the apparatus variants without generating any error in assembly or in version. The logistics involved in provisioning the components are therefore complex.

The subject of the present invention is therefore a device for generating an air stream at a set temperature and a heating and/or air-conditioning apparatus comprising this device which overcomes the disadvantages listed hereinabove.

The present invention simplifies the problems of manufacture and of assembly of versions of a heating and/or air-conditioning apparatus suited to different equipment levels of a motor vehicle and, in particular, to versions making it possible to deliver an air stream at a set temperature to one or more comfort regions in the cabin of a motor vehicle.

These objectives are achieved, according to the invention, through the fact that the device constitutes a modular assembly which can be attached into a casing of an apparatus for heating and/or air-conditioning the cabin of a motor vehicle, this modular assembly existing in at least two versions, suited at least to the production of an air stream at a set temperature for supplying an air stream at a set temperature to at least one region or two regions of the cabin of a motor vehicle, the external bulk of the modular assembly being identical regardless of the number of regions of the cabin for which it is intended.

By virtue of these features, the internal design of the casings is roughly identical regardless of the version of the heating apparatus. Management of tools and logistic problems are simplified. The risks of error are diminished.

The method of assembly is also simplified. When assembling the apparatus, the operator has merely to select the preassembled mixing module that corresponds to the variant that is to be manufactured. In a preferred alternative form of embodiment, the device comprises a support frame, a partition plate attached or incorporated into the support frame and dividing the latter into a hot air tunnel and a cold air tunnel, the support frame being able, depending on the version of the apparatus for which it is intended, to have no division of the hot air and cold air tunnels or to be divided by at least one region partition into at least two pairs of ducts, each pair of ducts consisting of a hot air duct and of a cold air duct, each pair of ducts comprising independent distribution means for splitting part of the main air stream in adjustable proportions between its hot air duct and its cold air duct.

As a preference, the device comprises aerothermal optimization arrangements to orientate at least the hot secondary air stream toward preferred areas of an internal volume of the casing of the air-conditioning apparatus. These aerothermal optimization arrangements may for example comprise arrangements for deflecting air and/or at least one rib for guiding or mixing air.

In one particular embodiment, the deflection arrangements comprise at least one upward deflector to orientate part of the hot air stream toward the upper part of the internal volume of the casing, at least one downward deflector to orientate part of the hot air stream toward the lower part of the internal volume of the casing, and at least one upward deflector to orientate at least part of the cold air stream toward the upper part of the same internal volume of the casing.

In one particular embodiment intended for a two-region heating apparatus, the device comprises a central region partition dividing the hot air tunnel into a left-hand hot air duct and a right-hand hot air duct and the cold air tunnel into a left-hand cold air duct and a right-hand cold air duct, and deflection arrangements comprising a central partition designed to divide the internal volume of the casing into a left-hand mixing chamber and a right-hand mixing chamber after the device has been mounted in a heating apparatus, at least one upward deflector and at least one downward deflector in the left-hand mixing chamber, at least one upward deflector and at least one downward deflector in the right-hand mixing chamber, and at least one upward deflector in the cold air tunnel.

In another particular alternative form intended for a three-region heating apparatus, the device comprises two region partitions dividing the hot air tunnel into three hot air ducts and the cold air tunnel into three cold air ducts and deflection arrangements comprising a central partition designed to divide the internal volume of the casing into a left-hand mixing chamber and a right-hand mixing chamber after the device has been mounted in a heating apparatus, at least one deflector in the left-hand mixing chamber and at least one deflector in the right-hand mixing chamber, and a box delimiting a mixing volume which fits onto one of the pairs of hot air and cold air ducts of the support frame, the box having a first air outlet intended, after the device has been mounted in a heating apparatus, to be placed facing an air outlet of the casing of the heating and/or air-conditioning apparatus so as to convey air to the rear seats of the vehicle.

The box may comprise a second air outlet intended, after the device has been mounted in a heating apparatus, to convey air to the front right and front left seats of the vehicle, an orientable shutter making it possible to shut off the first outlet or the second outlet depending on the air distribution mode chosen, for example the deicing mode.

Optional or additional features of the invention are listed below:

the support frame comprises means of connection to the casing of the heating and/or air-conditioning apparatus, allowing the module to be secured to the casing such that it is airtight;

the connecting means consist of a peripheral rib formed on the support frame and designed to engage in a corresponding slot of the casing of the heating and/or air-conditioning apparatus after the device has been mounted in the heating apparatus, or vice versa;

the connecting means consist of a peripheral groove formed on the support frame and designed to accommodate a corresponding push-in bead formed in an internal wall of the casing of the heating and/or air-conditioning apparatus;

the connecting means consist of two spaced-apart flanges formed on an exterior peripheral wall of the support frame and engaging between two more widely spaced flanges formed on an interior peripheral wall of the casing of the heating and/or air-conditioning apparatus, with the possibility of inserting a seal;

the connecting means consist of two seals with overmolded lips formed on an exterior peripheral wall of the support frame, the seals trapping between them a rib formed on an internal peripheral wall of the casing of the heating and/or air-conditioning apparatus;

the distribution means consist of at least one panel comprising a number of perforations, and a shutoff plate comprising a number of apertures, the shutoff plate being able to move between an open position in which it does not cover the perforations in the panel and a shutoff position in which it shuts off the perforations in the panel, at least one shutter for adjusting the passage cross section of the cold air duct able to move between an open position and a shutoff position, and a control mechanism for controlling in synchronism the movement of the shutoff plate and the movement of the shutter for adjusting the passage cross section of the cold air duct between their open position and their shutoff position;

the distribution means consist of at least one rotary shutter arranged in the cold air duct, and at least one rotary shutter arranged in the hot air duct.

In another aspect, the invention relates to an apparatus for heating and/or air-conditioning the cabin of a vehicle, which comprises a device for generating an air stream at a set temperature as defined hereinabove.

Other features and advantages of the present invention will become further apparent from reading the description which follows of some exemplary embodiments given by way of illustration with reference to the appended figures. In these figures:

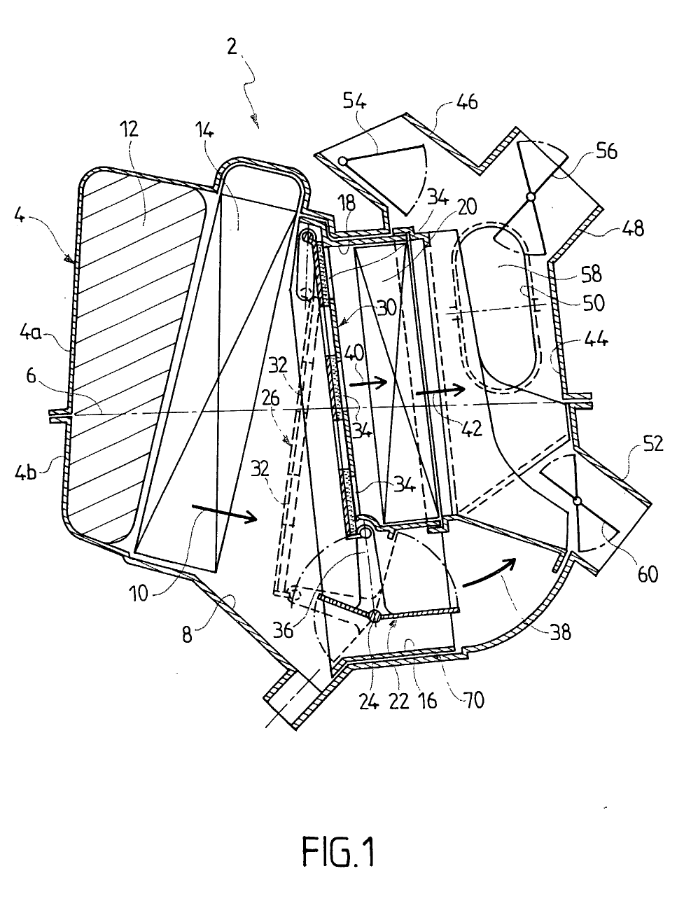

FIG. 1 is a sectional overall view of a single-region or two-region heating and/or air-conditioning apparatus comprising a modular device for generating a stream of air at a set temperature according to the present invention;

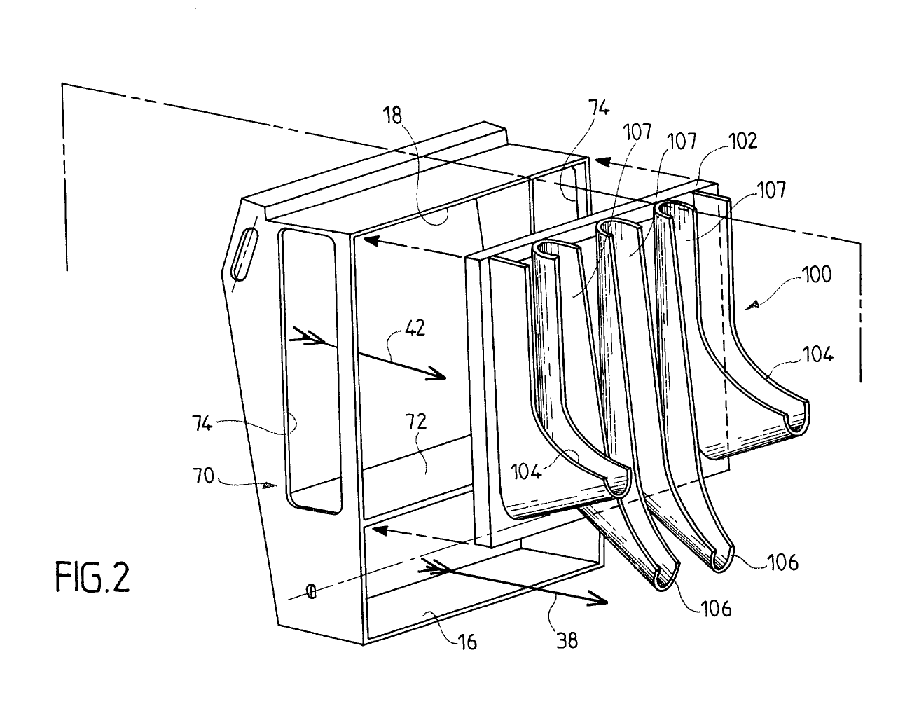

FIG. 2 is a perspective view of the deflection arrangements of the device depicted in FIG. 1, for a single-region apparatus;

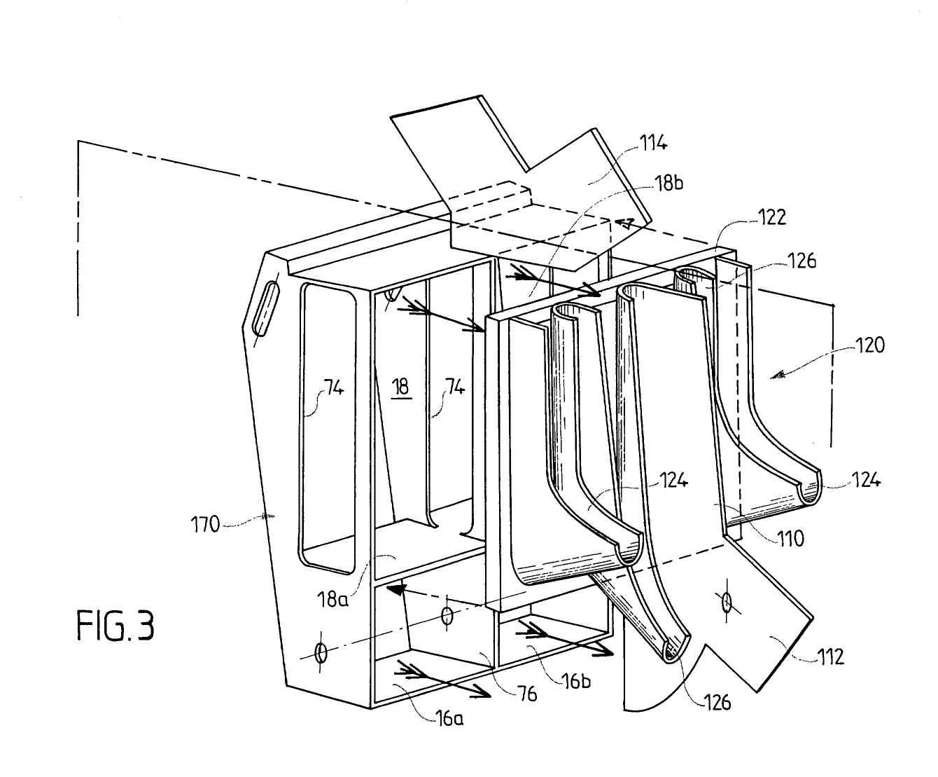

FIG. 3 is a perspective view of an alternative form of embodiment of the deflection arrangements of FIG. 1, for a two-region apparatus;

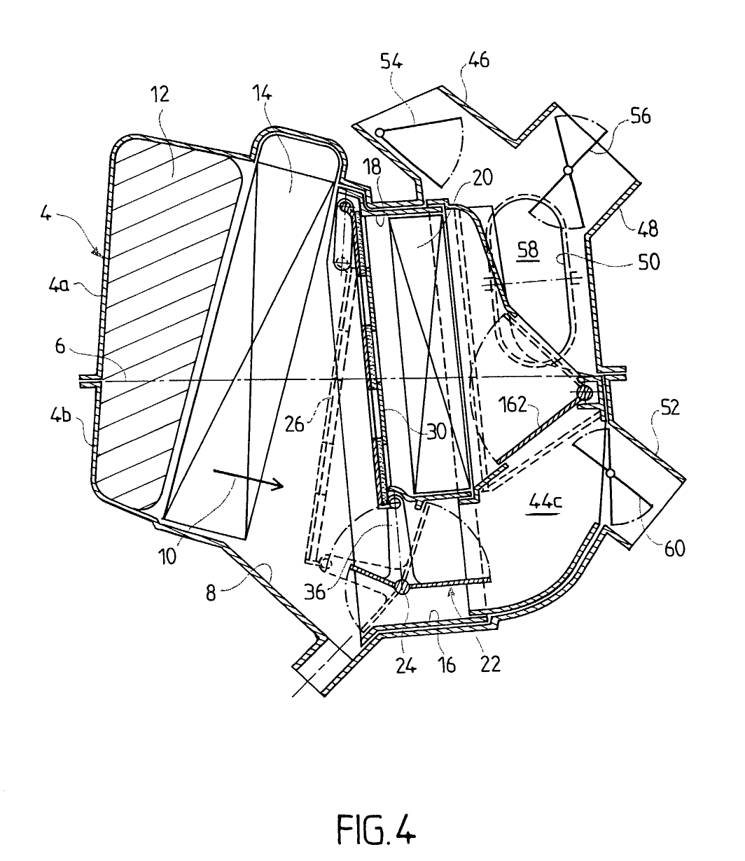

FIG. 4 is a sectional overall view of a three-region heating and/or air-conditioning apparatus comprising a modular device for generating an air stream according to the present invention;

FIG. 5 is a perspective view of the deflection arrangements of the device depicted in FIG. 4;

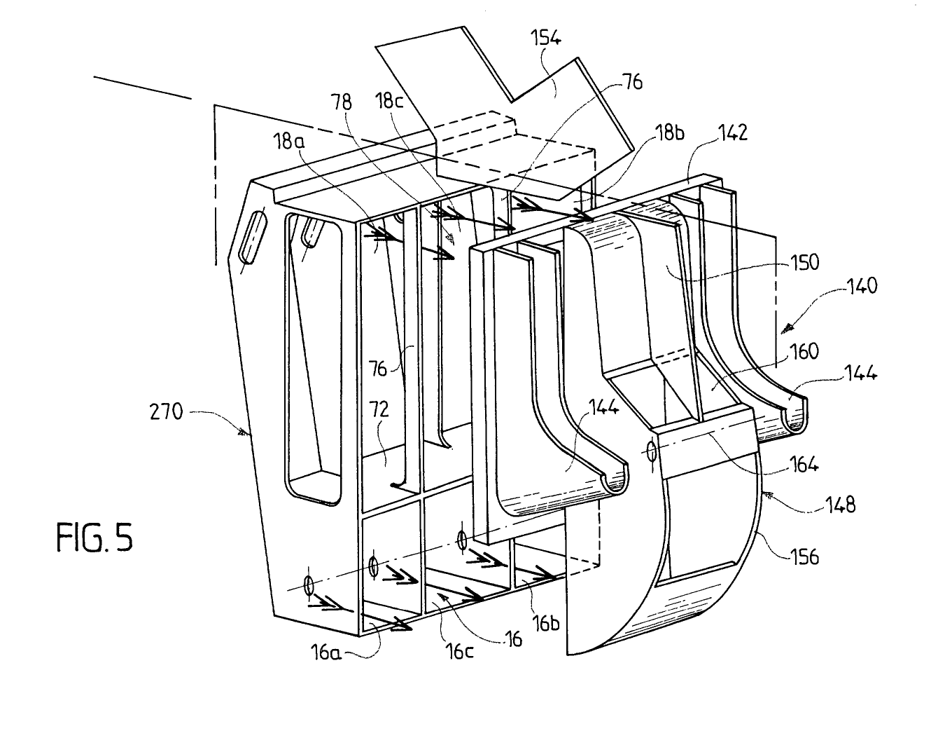

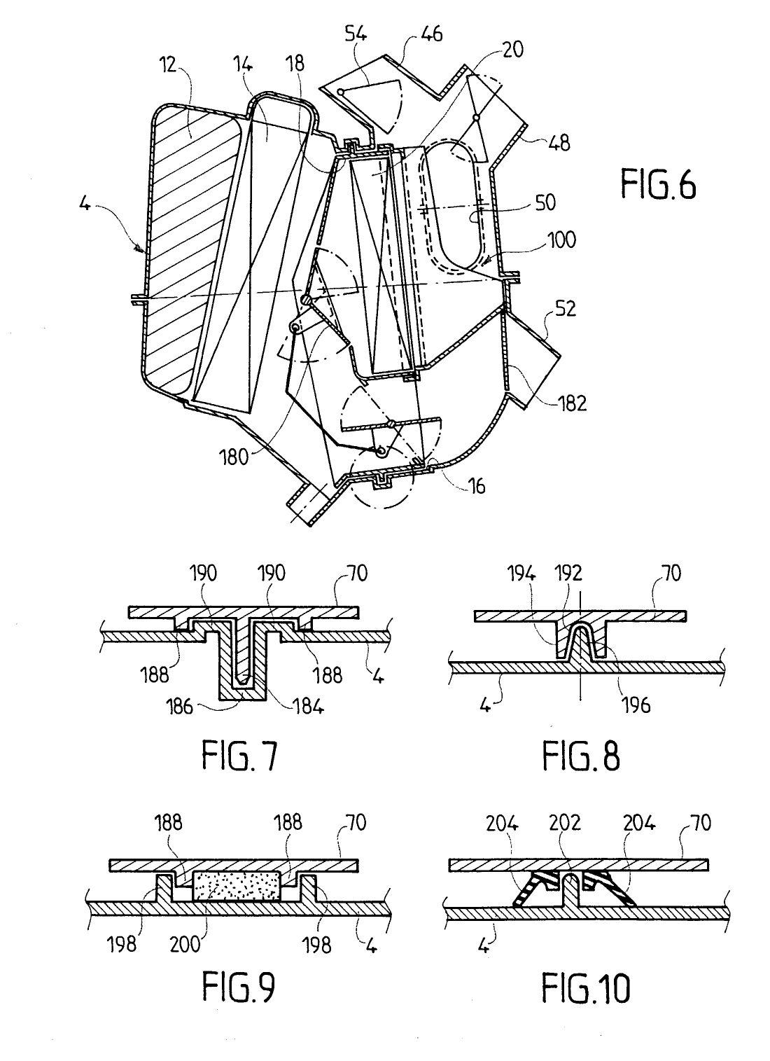

FIG. 6 is a sectional view of a single-region heating and/or air-conditioning apparatus comprising an entry-level variant of the modular device depicted in FIGS. 1 and 2;

FIGS. 7 to 10 are detailed views depicting airtight means of connecting the modular device of the invention to the casing of a heating and/or air-conditioning apparatus.

In FIG. 1, the apparatus for heating and/or air-conditioning the cabin of a vehicle denoted by the general reference 2 comprises a casing denoted by the general reference 4 consisting of an upper part 4a and of a lower part 4b which meet along a join plane 6 depicted in chain line. The casing 4 delimits a main passage 8 for a main air stream 10 which enters the casing via an air inlet 12. An evaporator 14 forming part of an air-conditioning circuit (not depicted) is mounted in the main passage 8 so that all of the air stream 10 passes through it. This has the advantage of dehumidifying this air. The main passage 8 splits into a cold air duct 16 situated at the lower part of the casing and a hot air duct 18 situated at the upper part of the casing. A heater matrix 20 is mounted in the hot air duct 18.

Distribution means are provided for splitting the main air stream 10 between the cold air duct 16 and the hot air duct 18. In the example depicted, these means consist of two distinct elements, namely a butterfly shutter 22 mounted to pivot about a spindle 24 and a shutoff plate 26. The pivoting shutter 22 can pivot between an open position, depicted in solid line in the figure, in which position the cold air duct 16 is open, and a closed position, depicted in dotted line, in which the cold air shutter 22 entirely shuts off the duct 16. The shutoff plate 26 can move in a combined movement of translation and rotation between an open position, depicted in dotted line in the figure, in which position it is away from a fixed perforated panel 30 mounted at the entry to the hot air duct 18 and a closed position in which it is applied against the perforated panel 30. The shutoff plate 26 comprises a series of openings 32 distributed along its length. Similarly, the panel 30 has perforations 34 distributed along its length. The openings in the plate 26 and the perforations 34 in the panel 30 are offset so that when the shutoff plate 26 is applied against the panel 30, the hot air duct 18 is entirely shut off.

The movement of the shutoff plate is controlled by that of the cold air shutter 22. For that purpose, the lower end of the shutoff plate is connected to an arm 36 of the cold air shutter 22. Thus, a single control allows the movement of both elements for distributing the main air stream 10 between the cold duct 16 and the hot duct 18 to be controlled. The main air stream 10 divides into a cold secondary stream 38 which passes through the duct 16 and a secondary stream 40, also cold, which enters the hot air duct 18. The cold air 40 is heated up as it passes through the heater matrix 20 and a heated secondary air stream 42 reemerges from the hot air duct 18. The cold stream 38 and the heated stream 42 mix back together in an internal volume of the casing 4 of the heating and/or air-conditioning apparatus 2 known as the mixing chamber 44.

The casing 4 comprises four air outlets connected to the mixing chamber 44, namely, respectively, an outlet 46 for deicing/demisting the windshield, a dashboard vent outlet 48 and an outlet 50 for heating the feet. An outlet 52 situated at the lower part of the mixing chamber 44 allows the rear seats of the cabin of the vehicle to be supplied with air at a set temperature. The distribution of the air flowing through these various outlets can be adjusted using adjusting shutters denoted respectively by the references 54, 56, 58 and 60.

The heating and air-conditioning apparatus 2 depicted in FIG. 1 is of the single-region type. It is possible to set separately the distribution of air flowing through each of the outlets 46, 48, 50 and 52 but there is just one setting of the temperature of this air for the apparatus. In other words, the temperature of the air is the same regardless of the point to which it is delivered in the cabin of the motor vehicle.

In the particular embodiment depicted in FIG. 1, the device for generating an air stream at a set temperature of the invention comprises a frame 70 which fits the internal peripheral surface of the casing 4 exactly. The connection between the frame 70 and the casing is airtight. The means which provide this airtightness will be described in greater detail later on. The support frame 70 is split into two parts, in the heightwise direction, by a horizontal partition plate 72 (see FIG. 2) which divides the internal volume of the frame into a hot air tunnel and a cold air tunnel. Given that the heating apparatus 2 depicted in FIG. 1 is of the single-region type, it has no internal division other than the division afforded by the partition plate 72. This being the case, the cold air tunnel coincides with the cold air duct 16 and the hot air tunnel coincides with the hot air duct 18.

FIG. 2 depicts a perspective view of the support frame 70 and of deflection arrangements 100 corresponding to the single-region variant of the device for generating an air stream at a set temperature of FIG. 1. The presence, within the frame 70, of the partition plate 72 will be noted, this plate dividing the internal volume of the frame into a cold air duct 16 situated at its lower part and a hot air duct 18 situated at its upper part. It will also be noted that the vertical walls of the frames 70 are pierced with elongate rectangular vertical openings 74 which allow the insertion of the heater matrix (not depicted in FIG. 2).

The air deflection arrangements comprise a frame 102 which fits the cross section of the hot air duct 18 exactly. An upward deflector 104 is formed at the left-hand part of the frame 102 and another upward deflector 104, identical to the first, is formed at the right-hand part of the frame 102. Two downward deflectors 106 are formed between the two deflectors 104. As their name suggests, the two upward deflectors 104 are intended to deflect the hot air stream 42 toward the upper part of the mixing chamber 44 so as to supply the outlets 46, 48 and 50 with air. By contrast, the two downward deflectors 106 are intended to direct part of the hot secondary stream 42 toward the lower part of the mixing chamber 44. This air is intended for the outlet 52 supplying the rear seats of the cabin of the motor vehicle.

It will be seen, in this alternative form of embodiment, that the deflecting arrangements 100 relate both to the hot air stream 42 which has passed through the hot air duct 18 and to the cold air stream 38 which has passed through the cold air duct 16. The two upward deflectors 104 deflect the hot air stream 42 toward the upper part of the mixing chamber 44, while the two downward deflectors 106 deflect the hot air stream 42 toward the lower part of the mixing chamber 44 are formed between the two deflectors 104. In addition, these deflectors 104 and 106 define three channels: a central channel 107 between the deflectors 106 and two lateral channels 107 each lying between a deflector 104 and a deflector 106. These three channels 107 constitute upward deflectors which allow part of the cold air stream 38 to be deflected toward the upper part of the mixing chamber.

As was explained earlier, the apparatus depicted in FIGS. 1 and 2 is of the single-region type. This is why the mixing chamber 44 has no internal division. The deflecting arrangements 100 depicted in FIG. 2 therefore include no separation tending to divide the mixing chamber 44 into two or more parts. In consequence, the temperature of the mixed air is the same for all of the regions of the cabin of the vehicle to which it is delivered.

FIG. 3 schematically illustrates a second embodiment of a modular device according to the present invention. This device is intended for a two-region heating apparatus. Like the first embodiment, it comprises a rectangular support frame 170 in the vertical walls of which elongate rectangular openings 74 are made for the insertion of the heater matrix. The interior space of the frame is divided, in the heightwise direction, into a cold air tunnel 16 situated at the lower part of the frame and a hot air tunnel 18 situated at the upper part of the frame by a horizontal partition plate 72. However, unlike in the embodiment described previously, the cold air tunnel 16 is in turn divided into two cold air ducts, namely a left-hand cold air duct 16a and a right-hand cold air duct 16b, by a vertical region partition 76 which stretches from the lower part to the upper part of the support frame 170. Likewise, the hot air tunnel 18 is divided, in the horizontal direction, into a left-hand hot air duct 18a and a cold air duct 18b by the region partition 76. It can also be seen that the region partition 76 also has passing through it an opening 74 identical to the elongate rectangular openings 74 provided in the vertical walls of the support frame 170. The support frame 170 is thus divided, in the horizontal direction, into two pairs of hot and cold ducts, namely the ducts 16a, 18a and 16b, 18b.

Each pair of ducts 16a, 18a on the one hand, and 16b, 18b on the other hand, has distribution means for splitting the main air stream 10 (FIG. 1) in adjustable proportions into a cold secondary air stream passing through the cold duct of the pair of ducts concerned and a secondary air stream for heating, which is introduced into the hot duct 18a or 18b of the pair of ducts concerned.

In the exemplary embodiment depicted in FIG. 3, these distribution means (not depicted) are identical to the distribution means of the first embodiment which are represented in FIGS. 1 and 2. They therefore consist of a cold air shutter 22 mounted to pivot about a spindle 24 and able to shut off the cold duct, and of a shutoff plate 26 which can move between an open position and a closed position. The difference between the two embodiments lies in the fact that, in the two-region variant, each pair of hot and cold ducts has its own distribution means. There is therefore a cold air shutter in the cold duct 16a and another cold air shutter, independent of the first, in the cold air duct 16b. Likewise, the hot air duct 18a can be shut off by a shutoff plate 26, while the hot duct 18b can be shut off by another shutoff plate independent of the first.

It can thus be seen that the vertical partition 76 delimits two independent and separate circuits in which air streams which do not communicate with one other flow. Each of these streams is intended, after re-mixing, to supply a particular region in the cabin of the motor vehicle. Given that, in this instance, the heating and air-conditioning apparatus is a two-region one, the left-hand circuit (16a, 18a) is intended to supply the left-hand part of the cabin of the vehicle, for example, while the right-hand part of the device is intended to supply the right-hand part of the cabin of the motor vehicle. Of course, this is merely one example and it goes without saying that the heating and air-conditioning apparatus could be arranged with some other spatial orientation. Thus, the support frame 70 or 170, instead of being vertical as in the examples described, could be placed in a horizontal position. It would also be possible to conceive of the left-hand part of the distribution device supplying the right-hand part of the cabin, and vice versa.

Just as the interior volume of the support frame 170 is divided into two independent circuits by the vertical region partition 76, the mixing chamber (FIG. 1) is split into two independent parts, in the right-left direction of the device, by a central partition 110. The central partition 110 has a continuation 112 which enters the outlet trunking 52 intended to supply air to the rear part of the cabin of the motor vehicle (FIG. 1). Furthermore, the central separating partition 110 is extended, at its upper part, by a secondary partition 114 in the shape of a V, the branches of which enter the outlets 46 and 48 respectively.

The air deflecting arrangements denoted by the general reference 120 comprise a rectangular frame 122, the perimeter of which exactly fits the perimeter of the hot air tunnel 18 of the frame 170. The central separating partition 110 is fixed to the frame 122. It forms part of the deflection arrangements 120. To the left of the central partition, according to the figure, there is an upward air deflector 124 and a downward air deflector 126. Similarly, to the right of the partition 110, there is a downward air deflector 126 and an upward air deflector 124. The function of the upward 124 and downward 126 deflectors is identical to that of the corresponding deflectors 104 and 106 described with reference to FIG. 2.

It can thus be seen that the vertical central region partition 76, extended by the central partition 110 and the secondary partition 114, delimits two separate heating and ventilation circuits independent of one another. The temperature of the air in each of the independent mixing chambers delimited by the central partition 110 can be set independently using the independent distribution means with which each of the hot and cold ducts 16a, 18a and 16b, 18b is provided. It is also possible to conceive of one of the ducts being in cold mode while the other is in hot mode. It is thus possible separately to set the temperature and the distribution of air in the left-hand and right-hand parts of the cabin of the motor vehicle.

It is important to emphasize that the casing 4 of the heating and air-conditioning apparatus in which the device is installed is identical in both embodiments. In particular, it is the central partition 110 which delimits two independent mixing chambers in the interior volume of the casing. The internal arrangements of the casing do not differ from one version to the other. Likewise, it is the interior arrangements of the frames 70 and 170 which delimit one or two independent heating and air-conditioning circuits. However, the external shape and dimensions of the support frame 70 and those of the frame 170 are identical, which means that these frames can be mounted in a single type of casing.

As was pointed out earlier, the casing 4 consists of two parts, an upper part 4a and a lower part 4b which meet along a join plane 6. This two-part construction allows the device of the invention to be inserted easily into one of the lower or upper halves of the casing, then for the casing to be closed again adding the second part.

FIGS. 4 and 5 depict a three-region heating and air-conditioning apparatus. This apparatus comprises a casing 4 which is exactly identical to the casing of the previous embodiments. The air inlet, the evaporator 14 and the heater matrix 20 are also identical in all three embodiments. The specifics of this embodiment are more particularly visible in FIG. 5 which, in perspective, depicts the support frame 270 and the air deflection arrangements 140 corresponding to this support frame.

The frame 270 is divided, in the heightwise direction, into a cold air tunnel 16 and a hot air tunnel 18 by a horizontal partition plate 72. Furthermore, the cold 16 and hot 18 air tunnels are themselves divided into three parts, in the left-right direction, into three independent circuits by two vertical region partitions 76. The two region partitions 76 divide the cold air tunnel 16 into a left-hand cold air duct 16a, a right-hand cold air duct 16b and a central cold air duct 16c.

Likewise, the region partitions 76 divide the hot air tunnel 18 into a left-hand cold air duct 18a, a right-hand cold air duct 18b and a central cold air duct 18c. Three pairs of ducts are defined in this way, and these are, respectively, a left-hand pair of hot and cold ducts 16a, 18a, a right-hand pair of hot and cold ducts 16b, 18b and a central pair of hot and cold ducts 16c, 18c. Each of these pairs of ducts forms part of a circuit for the independent heating and ventilation of a region of the motor vehicle.

Each pair of ducts has distribution means which allow the main air stream 10 (FIG. 1) to be split in variable proportions between the cold and hot ducts of each of the respective pairs of ducts. In the exemplary embodiment depicted, the distribution means of each pair of ducts consists of a cold air shutter 22 mounted to pivot about a spindle 24 and able to open or close the passage cross section of the respective cold duct 16a, 16b, 16c in which it is mounted.

The distribution means of each of the hot ducts 18a, 18b, 18c consist of a shutoff plate 26, each hot duct comprising a plate independent of that of the other ducts. It is thus possible independently to adjust the distribution of the air between the hot duct and the cold duct in each of the three pairs of ducts. The air deflecting arrangements denoted by the general reference 140 comprise a rectangular frame 142 the periphery of which exactly fits the periphery of the hot air tunnel 18.

The deflecting arrangements 140 further comprise a central separating partition 150 which splits the interior volume of the casing in which the device is mounted (FIG. 4) into a left-hand mixing chamber and a right-hand mixing chamber (neither depicted). As in the framework of the previous embodiment, the central separating partition is extended at its upper part by an auxiliary partition 154 in the shape of a V the branches of which are intended to engage in outlets 46 and 48 of the heating apparatus.

The deflection arrangements further comprise a left-hand upward air deflector 144 situated in the left-hand mixing chamber and a similar upward air deflector 144 situated in the right-hand mixing chamber. This embodiment, unlike the previous ones, has no downward air deflector. What happens in this variant is that the central hot and cold air circuit 18c, 16c is specially intended for supplying air at a set temperature to the rear seats of the vehicle. The deflection arrangements 140 comprise a box denoted by the general reference 148 having a vertical rectangular-shaped inlet which exactly fits the central hot and cold air circuit 18c, 16c. The interior volume delimited by the box 148 constitutes a separate mixing chamber 44c (FIG. 4) specific to the central hot and cold air circuit.

The central cold air stream flowing through the central cold air duct 16c, and the central hot air stream flowing through the central hot air duct 18c mix in this specific mixing chamber. The air at an intermediate temperature resulting from this mixing is directed toward the rear seats of the vehicle by the outlet 52. For this, the box 148 comprises an opening 156 situated facing the air outlet 52. Thus, the air can escape from the box 148 and enter the outlet 52. In a preferred embodiment, the box 148 may comprise an air outlet 160 situated at the upper part of the box.

An edge-pivoted shutter 162, pivoting about a axle 164 allows either the outlet 156 or the outlet 160 to be opened. Thus, while the apparatus is in normal operation, the shutter 162 closes the upper outlet 160 so that the lower outlet 146 is open and the air is directed toward the rear seats of the motor vehicle. By contrast, in deicing mode, the shutter 162 is in the position shown in solid line in FIG. 4. In other words, the hot air from the central hot air duct 18c is directed in its entirety toward the upper part of the mixing chamber 44c and escapes via the upper outlet 160. In this mode of operation, all of the hot air available is used to deice the windshield and the mode of heating the rear seats is not available.

Although, in the embodiments described, the heating apparatus comprises a single heater matrix 20 used for heating up the air for all of the hot air circuits, whether there be one, two or three hot circuits, it is possible to install several heat exchangers between the device or devices for distributing the air streams and the air deflection arrangements. It is thus possible to provide a heater matrix and a positive temperature coefficient (PTC) resistive element.

Likewise, it is possible to use distribution means other than those described. Instead of a pivoting cold air shutter and a shutoff plate, it is possible to use two pivoting shutters, namely a pivoting shutter 20 intended to regulate the passage of the air through the cold duct 16, and a pivoting shutter 180 (see FIG. 6) intended to regulate the flow of air through the hot duct 18. A distribution device of this type, the cost price of which is not as high, is intended for a single-region heating apparatus suitable for equipping an entry-level vehicle. It will be noted in particular that the deflecting arrangements 100 comprise a blanking plate 182 which shuts off the outlet 52 of the casing intended in theory for conveying the air to the rear seats of the vehicle.

In this simplified embodiment, there are just three air outlets rather than four as in the embodiments described previously. These three outlets correspond, respectively, to the outlet 46 for deicing/demisting the windshield, to the dashboard vent outlets 48 and to the outlet 50 for heating the feet. Thus, it can be seen that the shape of the casing and its internal arrangements are identical regardless of the version of the heating apparatus. The air outlet 52 intended for the rear seats of the cabin exists in all scenarios, even if it is not actually used in the simplest versions.

According to the invention, means are provided for, on the one hand, easily mounting the device for generating a stream of air at a set temperature of the invention in a casing such as the casing 4 of the heating and air-conditioning apparatus and, on the other hand, providing a sealed connection between the outer periphery of the frame 70, 170 or 270 depending on the version, and the internal wall of the casing 4 of the heating apparatus 2.

In FIG. 7, these connecting means consist of a peripheral rib 184 formed on the outer face of the frame 70. This rib, when the device is mounted in the casing, engages in a slot 186 the shape of which corresponds to that of the rib 184. Furthermore, the frame 70 comprises two parallel flanges 188 which tangentially hold the frame 70 on two shoulders 190 formed in the wall 4 of the casing.

In FIG. 8, a peripheral groove 192 is formed in a circular rib 194 provided at the periphery of the frame 70. A push-in bead 196 formed on a internal peripheral wall of the frame 4 fits into the groove 192. The fitting-together of these two parts both holds the device in the casing and seals the two parts.

In FIG. 9, the frame 70 comprises two spaced-apart flanges 188 which fit between two more widely spaced flanges 198 formed on an internal peripheral wall of the casing 4. A foam seal 200 inserted between the outer wall of the frame 70 and the inner wall of the casing 4 provides a sealed connection.

In FIG. 10, a peripheral rib 202 is formed on an interior peripheral wall of the frame 4. The two seals 204 with overmolded lips are formed on an exterior peripheral wall of the frame 70, on each side of the rib 202. The lips of the seals 204 provide sealing between the frame and the casing, while the fitting of the rib 202 between the two seals holds in place the device for generating an air stream at a set temperature.

1. A device for generating an air stream at a set temperature for supplying air at a set temperature to one or more regions of the cabin of a motor vehicle, comprising means for distributing a main air stream to split this air stream in adjustable proportions into a cold secondary air stream and a secondary air stream for heating, and heating means for heating the secondary air stream for heating so as to produce a hot secondary air stream,
which device comprises a modular assembly which can be attached into a casing of an apparatus for heating and/or air-conditioning the cabin of a motor vehicle, this modular assembly existing in at least two versions, suited to the production of an air stream at a set temperature for supplying an air stream at a set temperature to at least one region or two regions of the cabin of a motor vehicle, the external bulk of the modular assembly being identical regardless of the number of regions of the cabin for which it is intended.

2. The device as claimed in claim 1, and which comprises a support frame, a partition plate attached or incorporated into the support frame and dividing the latter into a hot air tunnel and a cold air tunnel, the support frame being able, depending on the version of the apparatus for which it is intended, to have no division of the hot and cold air tunnels or to be divided by at least one region partition into at least two pairs of ducts, each pair of ducts consisting of a hot air duct and of a cold air duct and comprising independent distribution means for splitting part of the main air stream in adjustable proportions between its hot air duct and its cold air duct.

3. The device as claimed in one of claims 1 and 2, and which comprises aerothermal optimization arrangements to orientate at least the hot secondary air stream toward preferred areas of an internal volume of the casing of the heating and/or air-conditioning apparatus.

4. The device as claimed in claim 3, wherein the aerothermal optimization arrangements comprise arrangements for deflecting air.

5. The device as claimed in claim 3, wherein the aerothermal optimization arrangements comprise at least one rib for guiding or mixing air.

6. The device as claimed in claim 3, wherein the deflection arrangements comprise at least one upward deflector to orientate part of the hot air stream toward the upper part of the internal volume of the casing, at least one downward deflector to orientate part of the hot air stream toward the lower part of the internal volume of the casing, and at least one upward deflector to orientate at least part of the cold air stream toward the upper part of the same internal volume of the casing.

7. The device as claimed in one of claims 2 to 6, intended for a two-region heating apparatus, which device comprises a central region partition dividing the hot air tunnel into a left-hand hot air duct and a right-hand hot air duct and the cold air tunnel into a left-hand cold air duct and a right-hand cold air duct, and deflection arrangements comprising a central partition designed to divide the internal volume of the casing into a left-hand mixing chamber and a right-hand mixing chamber, at least one upward air deflector and at least one downward air deflector in the left-hand mixing chamber, at least one upward air deflector and at least one downward air deflector in the right-hand mixing chamber, and at least one upward deflector in the cold air tunnel.

8. The device as claimed in one of claims 2 to 6, intended for a three-region heating apparatus, and which comprises two region partitions dividing the hot air tunnel into three hot air ducts and the cold air tunnel into three cold air ducts and air deflection arrangements comprising a central partition designed to divide the internal volume of the casing into a left-hand mixing chamber and a right-hand mixing chamber after the device has been mounted in an air-conditioning apparatus, at least one deflector in the left-hand mixing chamber and at least one deflector in the right-hand mixing chamber, and comprises a box delimiting a mixing volume which fits onto one of the pairs of hot air and cold air ducts of the support frame, the box having a first air outlet intended, after the device has been mounted in a heating and/or air-conditioning apparatus, to be placed facing an air outlet of the casing of the heating and/or air-conditioning apparatus so as to convey air to the rear seats of the vehicle.

9. The device as claimed in claim 8, wherein the outlet box comprises a second air outlet which opens toward the internal volume of the casing, an orientable shutter allowing the first or second air outlet to be shut off.

10. The device as claimed in one of claims 2 to 9, wherein the support frame comprises means of connection to the casing of the heating and/or air-conditioning apparatus, allowing the module to be secured to the casing such that it is airtight.

11. The device as claimed in claim 10, wherein the connecting means consist of a peripheral rib formed on the support frame and designed to engage in a corresponding slot of the casing of the heating and/or air-conditioning apparatus, or vice versa.

12. The device as claimed in claim 10, wherein the connecting means consist of a peripheral groove formed on the support frame and designed to accommodate a corresponding push-in bead formed in an internal wall of the casing of the heating and/or air-conditioning apparatus, or vice versa.

13. The device as claimed in claim 10, wherein the connecting means consist of two spaced-apart flanges formed on an exterior peripheral wall of the support frame and engaging between two more widely spaced flanges formed on an interior peripheral wall of the casing of the heating and/or air-conditioning apparatus, with the possibility of inserting a seal.

14. The device as claimed in claim 10, wherein the connecting means consist of two seals with overmolded lips formed on an exterior peripheral wall of the support frame, the seals trapping between them a rib formed on an internal peripheral wall of the casing of the heating and/or air-conditioning apparatus.

15. The device as claimed in one of claims 1 to 14, wherein the distribution means consist of at least one panel comprising a number of perforations, and a shutoff plate comprising a number of apertures, the shutoff plate being able to move between an open position in which it does not cover the perforations in the panel and a shutoff position in which it shuts off the perforations in the panel, at least one shutter for adjusting the passage cross section of the cold air duct able to move between an open position and a shutoff position, and a control mechanism for controlling in synchronism the movement of the shutoff plate and the movement of the shutter for adjusting the passage cross section of the cold air duct between their open position and their shutoff position.

16. The device as claimed in one of claims 1 to 14, wherein the distribution means consist of at least one rotary shutter arranged in the cold air duct, and at least one rotary shutter arranged in the hot air duct.

17. An apparatus for heating and/or air-conditioning the cabin of a vehicle, and which comprises a device for generating an air stream at a set temperature as claimed in any one of claims 1 to 16.
